(19) United States
(12) Patent Application Publication
(10) Pub. No.: US 2025/0080565 A1
(43) Pub. Date: Mar. 6, 2025

(54) DISPLAY DEVICE, DISPLAY METHOD, AND RECORDING MEDIUM

(71) Applicant: NEC Corporation, Tokyo (JP)

(72) Inventors: Shota Kizukuri, Tokyo (JP); Takahisa Yutoku, Tokyo (JP); Yoshihiko Koizumi, Tokyo (JP); Kazutoshi Koike, Tokyo (JP); Satoru Yamada, Tokyo (JP)

(73) Assignee: NEC Corporation, Tokyo (JP)

(21) Appl. No.: 18/809,613

(22) Filed: Aug. 20, 2024

(30) Foreign Application Priority Data
Aug. 29, 2023 (JP) 2023-138973

(51) Int. Cl. H04L 9/40

(52) U.S. Cl. CPC H04L 63/1433

(57) ABSTRACT

A display device of the present disclosure includes an identification means for identifying an organization unit name for managing each network asset included in a cyber security risk assessment target and identification information of the each network asset, an assessment acquisition means for acquiring a third-party assessment value for each organization based on information identifying the organization unit name and the identification information of the each network asset, and a display means for displaying the third-party assessment value for the each organization.

This application is based upon and claims the benefit of priority from Japanese Patent Application No. 2023-138973, filed on Aug. 29, 2023, the disclosure of which is incorporated herein in its entirety by reference.

### TECHNICAL FIELD

The present disclosure relates to a display device, a display method, and a recording medium.

### BACKGROUND ART

Results assessed by a third-party regarding a cyber security countermeasure state in an organization may be used.

For example, JP 2013 041372 A discloses a technique of generating assessment information about a web site to be assessed in terms of security by using information about a security state of the web site to be assessed acquired from an information providing site.

One example of the objectives of the present disclosure makes it possible to easily grasp the problematic part of the cyber security state in an organization.

### SUMMARY

A display device according to an aspect of the present disclosure includes an identification means for identifying an organization unit name for managing each network asset included in a cyber security risk assessment target and identification information of the each network asset, an assessment acquisition means for acquiring a third-party assessment value for each organization based on information identifying the organization unit name and the identification information of the each network asset, and a display means for displaying the third-party assessment value for the each organization.

A display method executed by a computer according to an aspect of the present disclosure includes identifying an organization unit name for managing each network asset included in a cyber security risk assessment target and identification information of each network asset, acquiring a third-party assessment value for each organization based on information identifying the organization unit name and the identification information of the each network asset, and displaying the third-party assessment value for the each organization.

A non-transitory recording medium according to an aspect of the present disclosure stores a program for causing a computer to execute the steps of identifying an organization unit name for managing each network asset included in a cyber security risk assessment target and identification information of the each network asset, acquiring a third-party assessment value for each organization based on information identifying the organization unit name and the identification information of the each network asset, and displaying the third-party assessment value for the each organization.

### BRIEF DESCRIPTION OF THE DRAWINGS

Exemplary features and advantages of the present invention will become apparent from the following detailed description when taken with the accompanying drawings in which:

FIG. 1 is a functional block diagram illustrating an example of a configuration of a display device in the present disclosure;

FIG. 2 is a diagram illustrating a hardware configuration in which the display device according to the present disclosure is implemented by a computer device and its peripheral devices;

FIG. 3 is an example of a display screen of a third-party assessment value for each organization in the present disclosure;

FIG. 4 is a flowchart illustrating an operation of the display device in the present disclosure;

FIG. 5 is an example of a display screen showing a difference in the third-party assessment value from a predetermined period ago for each organization in the present disclosure;

FIG. 6 is a functional block diagram illustrating an example of a configuration of a display device in the present disclosure;

FIG. 7 is an example of a display screen illustrating a response state to the cyber security risk in the present disclosure; and

FIG. 8 is a flowchart illustrating an operation of the display device according to the present disclosure.

### EXAMPLE EMBODIMENT

Hereinafter, example embodiments of a display device, a display method, a program, and a non-transitory recording medium recording the program according to the present disclosure will be described in detail with reference to the drawings. The present example embodiment does not limit the disclosed technology.

### First Example Embodiment

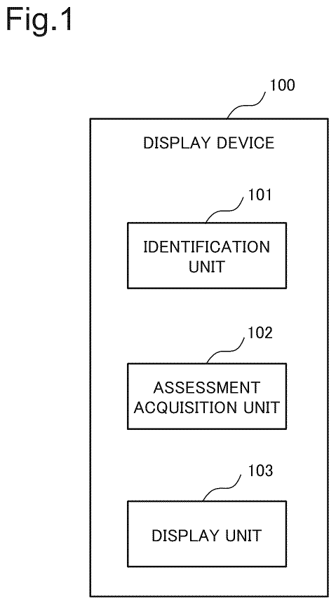

FIG. 1 is a functional block diagram illustrating an example of a configuration of a display device 100 in the present disclosure. Referring to FIG. 1, the display device 100 includes an identification unit 101, an assessment acquisition unit 102, and a display unit 103.

The display device 100 is a device for visualizing a third-party assessment value for each network asset owned by a company or the like for each organization in the company that manages each network asset. In the present disclosure, each network asset is stored in, for example, a storage device 505 in association with an organization unit name for managing the network asset and identification information of the network asset.

The organization unit name is not particularly limited as long as it is a name in a case where the entire organization is divided into a plurality of groups. The organization unit name may be, for example, a name of an organization allocated to each business unit or each area of a place of business in a company, a subsidiary of a company, or an organization unit name obtained by further subdividing them.

The network asset in the present disclosure is an asset of an organization connected to the Internet, and includes hardware such as a router, a switch, a hub, a host computer, a server, and a wireless access point, and software such as an operating system (OS), an application, and a patch.

The third-party assessment value will be described. The third-party assessment value is a value obtained by an external institution scoring the cyber security risk state of the network assets included in the assessment target based on information that can be acquired via the Internet. The third-party assessment value is calculated based on whether each assessment item for assessing the cyber security risk state is satisfied, and the assessment value is adjusted according to the number of network assets.

Examples of the assessment item of the cyber security risk state include a security countermeasure state in an organization, a malware infection sign, and the like. Examples of the security countermeasure state include the presence or absence of use of undesirable software, the presence or absence of compliance with best practices for security setting of network assets, and the like. However, the assessment item described above is an example, and other assessment items may be used as long as the assessment items can assess the cyber security risk state.

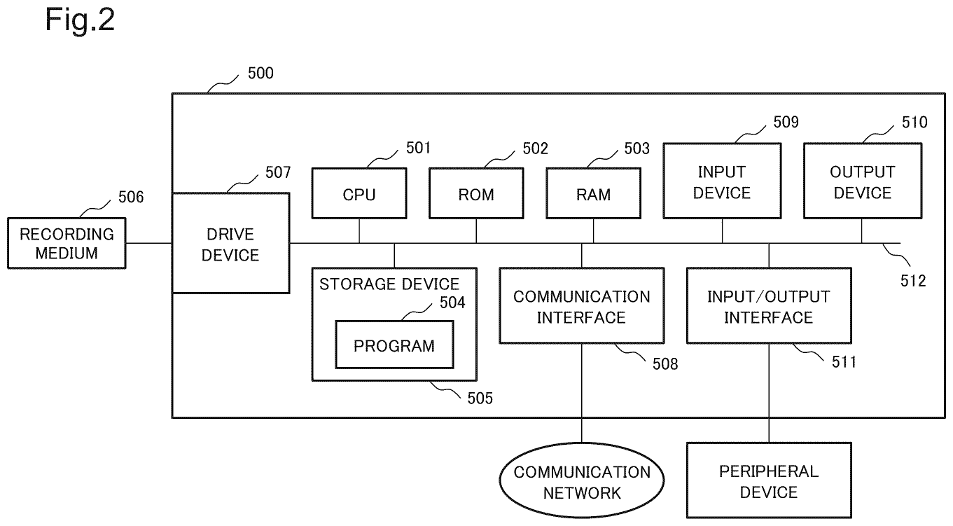

FIG. 2 is a diagram illustrating an example of a hardware configuration in which the display device 100 in the present disclosure is achieved by a computer device 500 including a processor. As illustrated in FIG. 2, the display device 100 includes a memory such as a central processing unit (CPU) 501, a read only memory (ROM) 502, and a random access memory (RAM) 503, the storage device 505 such as a hard disk that stores a program 504, a communication interface 508 for network connection, and an input/output interface 511 that inputs and outputs data.

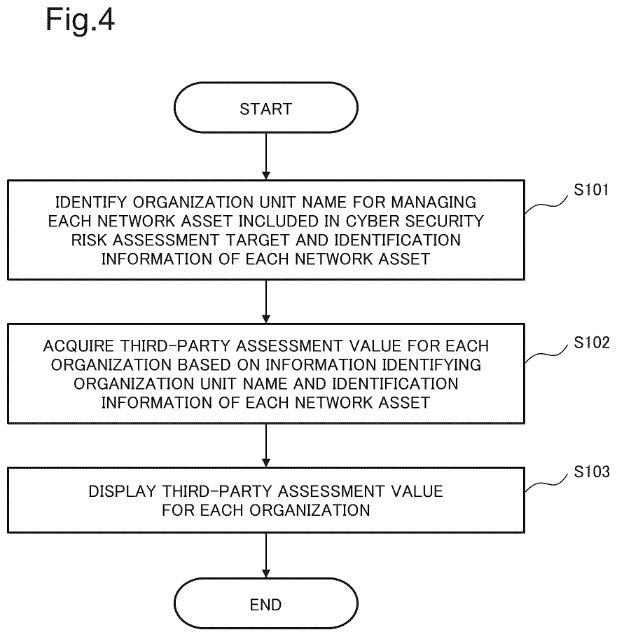

The CPU 501 operates the operating system to control the entire display device 100 according to the present disclosure. The CPU 501 reads a program and data from a recording medium 506 attached to a drive device 507 or the like to a memory, for example. The CPU 501 functions as the identification unit 101, the assessment acquisition unit 102, the display unit 103, and part thereof in the example embodiment of the present disclosure, and executes processing or a command in the flowchart illustrated in FIG. 4 to be described later based on a program.

The recording medium 506 is, for example, an optical disk, a flexible disk, a magnetic optical disk, an external hard disk, a semiconductor memory, or the like. Part of the recording medium of the storage device is a nonvolatile storage device, and records a program therein. The program may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display, and is used to check the display.

As described above, the display device 100 in the present disclosure is achieved by the computer hardware illustrated in FIG. 2. However, the means for achieving each unit included in the display device 100 in FIG. 1 is not limited to the above-described configuration. The display device 100 may be achieved by one physically coupled device, or may be achieved by a plurality of devices by connecting two or more physically separated devices in a wired or wireless manner. The display device 100 may further include an output device such as a display, or a device different from the display device 100 may include a display. The display device 100 in the present disclosure can also be configured by cloud computing or the like.

The identification unit 101 is a means for identifying an organization unit name for managing each network asset included in the cyber security risk assessment target and identification information of each network asset. The identification information is not particularly limited as long as the identification information can identify the network asset in a case where the network asset is accessed via the Internet, and is, for example, an internet protocol (IP) address or a host name. The identification unit 101 identifies the organization unit name that manages each network asset and the identification information of each network asset based on information stored in the storage device 505 or the like and in which the organization unit name that manages each network asset and the identification information of each network asset are associated with each other. The identification unit 101 outputs the identified information to the assessment acquisition unit 102.

The assessment acquisition unit 102 is a means for acquiring a third-party assessment value for each organization based on information identifying the organization unit name and identification information of each network asset. The assessment acquisition unit 102 acquires the above-described score using the network asset managed by each organization as an assessment target.

More specifically, the assessment acquisition unit 102 acquires the third-party assessment value for each organization by the following procedure. That is, first, the assessment acquisition unit 102 transmits association information of the organization unit name and the identification information of each network asset to an external server of an external assessment institution. Next, a third-party assessment value calculated by an external assessment institution for the network asset managed by each organization as an assessment target is received. Transmission and reception of information between the display device 100 and the external server are performed through, for example, an application programming interface (API). Upon acquiring the third-party assessment value for each organization, the assessment acquisition unit 102 outputs the information to the display unit 103.

The display unit 103 is a means for displaying the third-party assessment value for each organization. The display unit 103 causes the output device 510 or the like to display the third-party assessment value for each organization. The display unit 103 may generate a screen indicating the third-party assessment value for each organization, and cause a device different from the display device 100 to display the generated screen.

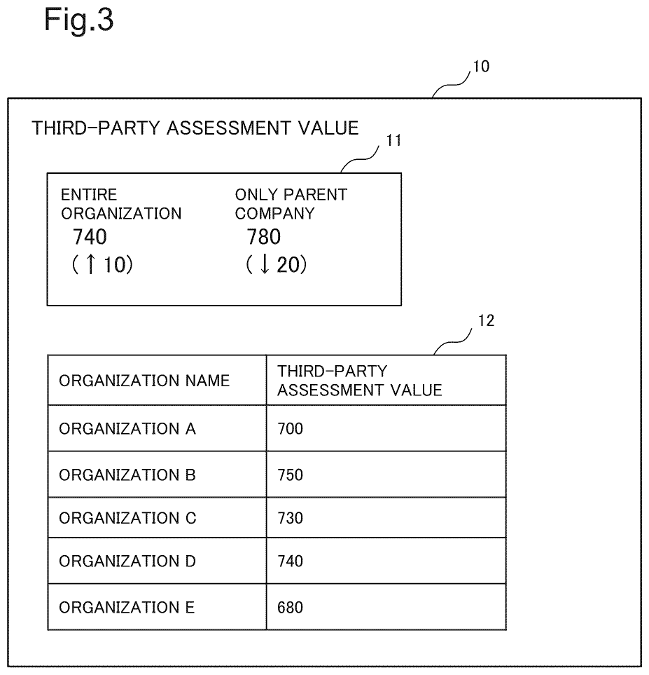

FIG. 3 is an example of a display screen of a third-party assessment value for each organization in the present disclosure. However, FIG. 3 is an example of displaying the third-party assessment value for each organization, and is not limited to the example of FIG. 3. A display screen 10 of the third-party assessment value in FIG. 3 includes a display area 11 of the third-party assessment value of the entire organization and a display area 12 of the third-party assessment value for each organization.

In FIG. 3, the display area 11 of the third-party assessment value of the entire organization displays the third-party assessment value of the entire organization and the third-party assessment value of the main organization. In the example of FIG. 3, the organization is a series of companies having a capital relationship, and a third-party assessment value of the parent company is displayed as a main organization. In the example of FIG. 3, a change from a predetermined period ago (for example, one day ago) is displayed next to each of the third-party assessment value of the entire organization and the third-party assessment value of the parent company. In the display device 100 according to the present disclosure, it is not essential to display the third-party assessment value of the entire organization. As for the third-party assessment value of the entire organization, as in the third-party assessment value for each organization, the assessment acquisition unit 102 acquires the third-party assessment value using the network asset held by the entire organization as an assessment target, and the display unit 103 displays the acquired third-party assessment value.

In FIG. 3, in the display area 12 of the third-party assessment value for each organization, the third-party assessment values using the network assets managed by the organizations A to E as assessment targets are displayed. In the example of FIG. 3, for example, it can be grasped that the network asset managed by the lowest organization E whose third-party assessment value is the lowest among the third-party assessment values of the other organizations has at least a security risk problem.

The operation of the display device 100 configured as described above will be described with reference to the flowchart of FIG. 4.

FIG. 4 is a flowchart illustrating an outline of the operation of the display device 100 in the present disclosure. The processing according to this flowchart may be executed based on program control by the processor described above.

As illustrated in FIG. 4, first, the identification unit 101 identifies an organization unit name for managing each network asset included in the cyber security risk assessment target and identification information of each network asset (step S101). Next, the assessment acquisition unit 102 acquires the third-party assessment value for each organization based on the information identifying the organization unit name and the identification information of each network asset (step S102). Finally, the display unit 103 displays the third-party assessment value for each organization (step S103). Thus, display device 100 ends the operation.

In the display device 100 according to the present disclosure, the assessment acquisition unit 102 acquires the third-party assessment value for each organization based on the information identifying the organization unit name and the identification information of each network asset, and the display unit 103 displays the third-party assessment value for each organization. Therefore, by displaying the third-party assessment value for each organization, it is possible to easily grasp the problematic part of the cyber security state in the organization.

### First Modification

Next, a modification of the first example embodiment will be described in detail with reference to the drawings. Hereinafter, description of content overlapping with the above description will be omitted to the extent that the description of the present example embodiment is not unclear. As in the computer device illustrated in FIG. 2, each component in each example embodiment of the present disclosure can be achieved not only by hardware but also by a computer device or software based on program control.

The assessment acquisition unit 102 in the present modification further acquires a third-party assessment value obtained a predetermined period ago for each organization. For example, the assessment acquisition unit 102 stores the third-party assessment value for each organization in the storage device 505 every time the third-party assessment value is acquired from the external server to acquire the third-party assessment value obtained a predetermined period ago for each organization from the storage device 505. The predetermined period is, for example, one day to thirty days, and is a period required to take measures against the designated cyber security risk.

The display unit 103 in the present modification further displays a difference in the third-party assessment value from a predetermined period ago for each organization. The display unit 103 displays a difference between a third-party assessment value acquired most recently by the assessment acquisition unit 102 and a third-party assessment value obtained a predetermined period ago. For example, the display unit 103 displays the difference between the most recently acquired third-party assessment value and the third-party assessment value obtained a predetermined period ago side by side.

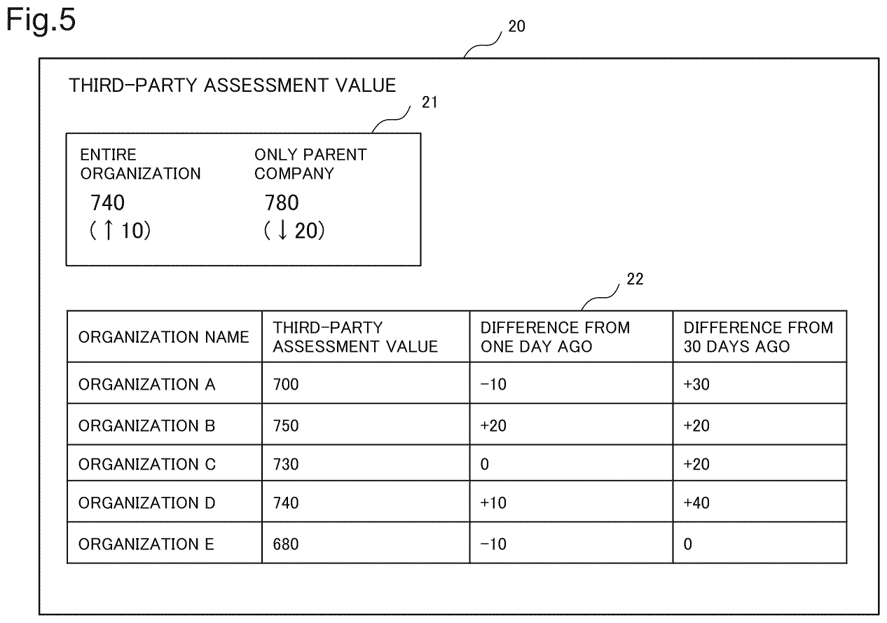

FIG. 5 is an example of a display screen displaying a difference in the third-party assessment value from a predetermined period ago for each organization in the present disclosure. A display screen 20 of the third-party assessment value in FIG. 5 includes a display area 21 of the third-party assessment value of the entire organization and a display area 22 of the third-party assessment value for each organization. In FIG. 5, the display area 21 of the third-party assessment value of the entire organization is similar to the display area 11 of the third-party assessment value of the entire organization in FIG. 3.

In the display area 22 of the third-party assessment value for each organization in FIG. 5, a difference in the third-party assessment value from a predetermined period ago is displayed next to the third-party assessment value using the network assets managed by the organizations A to E as assessment targets. In the example of FIG. 5, the difference in the third-party assessment value from one day ago and the difference in the third-party assessment value from 30 days ago are displayed. By displaying such a screen, it is possible to grasp a change in the third-party assessment value, compared with the third-party assessment value one day ago and the third-party assessment value 30 days ago.

In the display device 100 according to the present disclosure, the assessment acquisition unit 102 acquires the third-party assessment value obtained a predetermined period ago for each organization, and the display unit 103 displays the difference in the third-party assessment value from the predetermined period ago for the each organization. This makes it possible to grasp a change in the cyber security risk state of each organization.

### Second Modification

Next, another modification of the first example embodiment will be described in detail with reference to the drawings. Hereinafter, description of content overlapping with the above description will be omitted to the extent that the description of the present example embodiment is not unclear.

The assessment acquisition unit 102 according to the present modification acquires, in addition to the function of the assessment acquisition unit 102 according to the first example embodiment, a reference value for the third-party assessment for each organization. The reference value is, for example, a target value of the third-party assessment value set for each organization, but is not limited thereto as long as it is a value to be compared in order to determine whether the third-party assessment value for each organization is appropriate. The reference value for the third-party assessment for each organization is stored in, for example, the storage device 505, and the assessment acquisition unit 102 acquires the reference value for the third-party assessment of each organization from the storage device 505.

In addition to the function of the display unit 103 of the first example embodiment, the display unit 103 of the present modification displays the third-party assessment in a different mode according to the difference from the reference value for each organization. For example, the display unit 103 may display the color of the display area of the third-party assessment value or the character font of the third-party assessment value differently between a case where the third-party assessment value is higher than the reference value and a case where the third-party assessment value is lower the reference value. The display unit 103 may display the third-party assessment in different modes according to the degree of difference from the reference value. For example, the display unit 103 may display the third-party assessment value with an emphasized manner in a case where the third-party assessment value is different by 20 from the reference value, compared with in a case where the third-party assessment value is different by 10.

The display device 100 according to the present modification further acquires a reference value for the third-party assessment for each organization, and the display unit 103 further displays the third-party assessment in a different mode according to a difference from the reference value for the each organization. This makes it easy to grasp the difference from the reference value of the cyber security risk state of each organization.

### Second Example Embodiment

Next, the second example embodiment will be described in detail with reference to the drawings. Hereinafter, description of content overlapping with the above description will be omitted to the extent that the description of the present example embodiment is not unclear. As in the computer device illustrated in FIG. 2, each component in each example embodiment of the present disclosure can be achieved not only by hardware but also by a computer device or software based on program control.

In the present example embodiment, a scene is assumed in which a response state to the cyber security risk pointed out to each organization is displayed. The cyber security risk pointed out to each organization is classified into diagnosis categories such as a third-party assessment value, a cyber security problem pointed out by an external institution, disclosure of authentication information on the dark web and the like, exposure of internal documents and the like on the Internet, and vulnerability with a high degree of urgency. However, these diagnosis categories are examples of the designated cyber security risks, and other risks may be designated.

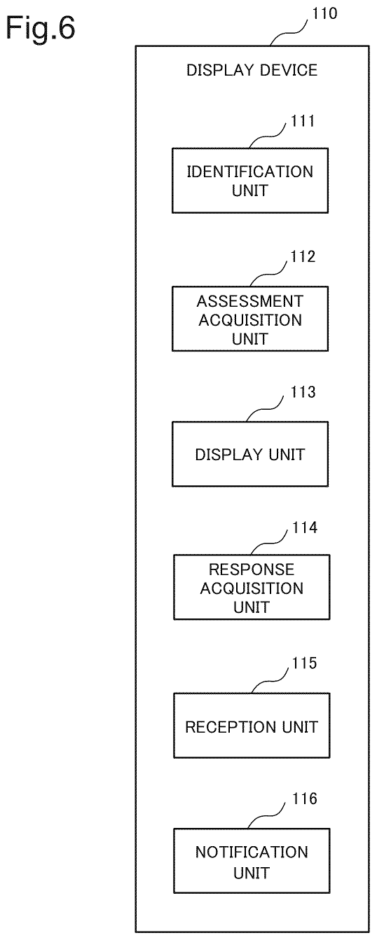

FIG. 6 is a functional block diagram illustrating an example of a configuration of a display device in the present disclosure. With reference to FIG. 6, a display device 100 will be described focusing on a portion different from the display device 110.

The display device 110 includes an identification unit 111, an assessment acquisition unit 112, a display unit 113, a response acquisition unit 114, a reception unit 115, and a notification unit 116. Since the configuration and function of the identification unit 111 and the assessment acquisition unit 112 in the display device 110 are similar to those of the identification unit 101 and the assessment acquisition unit 102 in the display device 100, the description thereof will be omitted here.

The response acquisition unit 114 is a means for acquiring a response state to the cyber security risk pointed out for each organization. For example, the response acquisition unit 114 first transmits the cyber security risk pointed out for each organization to the person-in-charge terminal of each organization. The response acquisition unit 114 acquires the presence or absence of a response to the designated cyber security risk based on the presence or absence of reception of a response signal indicating that the response has been completed from the person-in-charge terminal of each organization.

In addition to the function of the display unit 103, the display unit 113 displays a response state to the cyber security risk for each organization. For example, the display unit 113 displays a list of the response state to the cyber security risk for each organization. In this case, the display unit 113 displays that the cyber security risk for which the response signal has been received has been responded. On the other hand, the display unit 113 displays that the cyber security risk for which the response signal has not been received has not been responded.

The reception unit 115 is a means for receiving information about the cyber security risk to be displayed in the response state. The reception unit 115 receives input of information about the cyber security risk to be displayed from the operator of the display device 110.

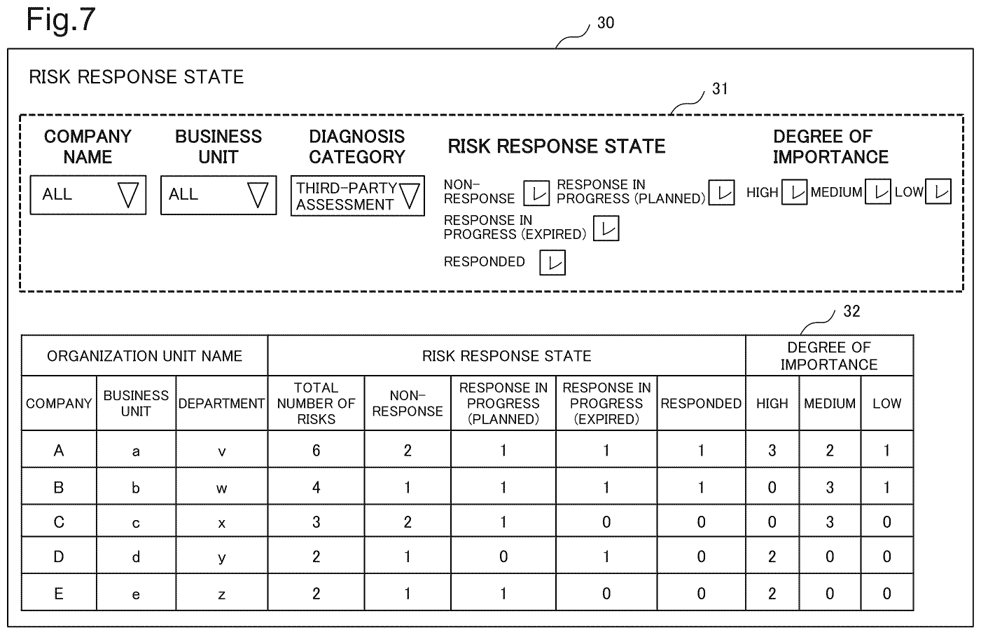

FIG. 7 is an example of a display screen of a response state to the cyber security risk in the present disclosure. A display screen 30 in FIG. 7 includes a filtering area 31 for filtering the response state to be displayed and a display area 32 for the response state.

In the example of FIG. 7, the organization unit name is displayed in three hierarchies of a company name, a business unit, and a department. The third-party assessment is selected as the diagnosis category of the cyber security risk. the response state to the cyber security risk is displayed in four states of a non-response, a response in progress (planned), a response in progress (expired), and response. The non-response refers to a state in which there is no contact from the organization with respect to the cyber security risk pointed out. The response in progress (planned) refers to a state in which a contact has been received from the organization regarding the deadline for responding the risk pointed out, and the response in progress (expired) refers to a state in which a signal indicating responded has not been received even after the designated deadline for responding the risk. In the example of FIG. 7, the degree of importance of the risk is displayed in three levels of high, medium, and low.

In the example of FIG. 7, in the filtering area 31, each of the organization unit name of the risk to be displayed, the response state to the risk, and the degree of importance of the risk can be selected by pull-down or by adding a check mark in a checkbox. The reception unit 115 receives the information about the cyber security risk selected in the filtering area 31.

In the example of FIG. 7, for the organization, it is selected to display the cyber security risks of all company names and all business unit names. As described above, although the third-party assessment is selected as the diagnosis category of the cyber security risk, it is also possible to select another diagnosis category. In the example of FIG. 7, as the response state to be displayed, all four items in the response state are selected, and all three levels of degree of importance are selected.

In the display area 32, the response state to the cyber security risk related to the received information of the cyber security risk is displayed in a list form. In the example of FIG. 7, the number of cyber security risks related to the response state to each risk and each degree of importance are displayed for each organization unit name. As in the example of FIG. 7, by displaying the number of response states to each risk, it is possible to grasp the number of cyber security risks that is required to be handled. By displaying the number of levels of degree of importance, it is possible to grasp the number of cyber security risks that is required to be preferentially handled. By making it possible to select the organization unit name of the cyber security risk or the response state to the risk to be displayed, it is possible to display only information that the operator requires, and thus, it is possible to enhance the visibility of information.

In a case where the response state to the cyber security risk is changed, the display unit 113 may display the updated third-party assessment value for each organization. The external server periodically assesses the cyber security risk state of the network assets included in the assessment target, and updates the third-party assessment value. For example, in a case where the number of unhandled cyber security risks decreases and the number of handled cyber security risks increases, the third-party assessment value increases. The assessment acquisition unit 112 periodically acquires the third-party assessment value from the external server, and the display unit 113 displays the third-party assessment value acquired most recently.

The notification unit 116 is a means for making notification to the person-in-charge terminal of the organization in a case where the cyber security risk is not responded to for a predetermined period or more. For example, in the example of FIG. 7, the notification unit 116 automatically notifies the person-in-charge terminal of a message urging a response to the cyber security risk for a non-response and a response in progress (expired). The notification unit 116 may notify not only the person-in-charge terminal but also the terminal of the organization manager of the message according to the degree of importance of the cyber security risk.

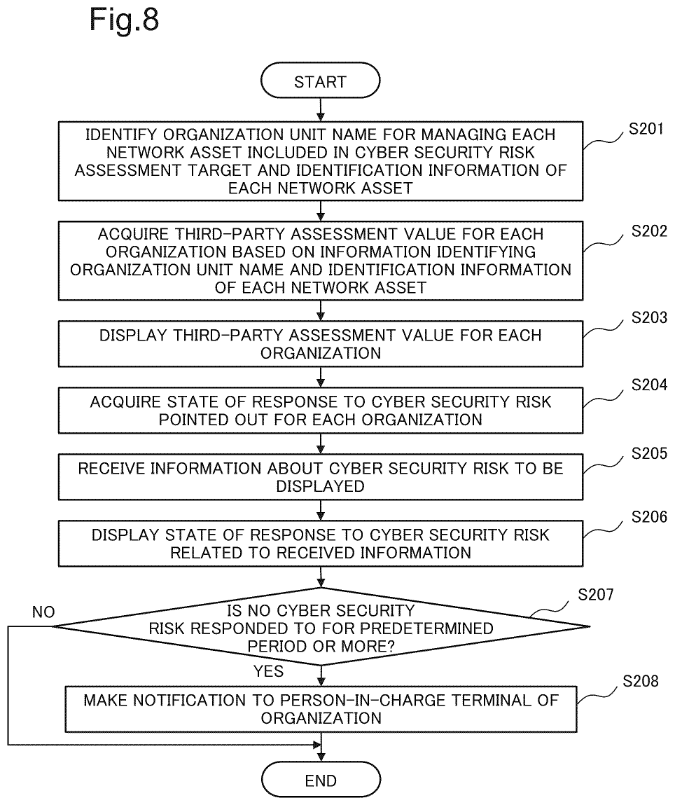

The operation of the display device 110 configured as described above will be described with reference to the flowchart of FIG. 8.

FIG. 8 is a flowchart illustrating an outline of the operation of the display device 110 in the second example embodiment. The processing according to this flowchart may be executed based on program control by the processor described above.

In FIG. 8, the flow of steps S201 to S203 is similar to the flow of steps S101 to S103 of the first example embodiment. The flow after step S204 does not need to be performed continuously with the flow from steps S201 to S203, and for example, an operation for displaying the response state to the cyber security risk is performed by the operator as a trigger. Similarly, the flow of steps S207 to S208 does not need to be performed subsequent to the flow of steps S204 to S206.

As illustrated in FIG. 8, first, the identification unit 111 identifies an organization unit name for managing each network asset included in the cyber security risk assessment target and identification information of each network asset (step S201). Next, the assessment acquisition unit 112 acquires the third-party assessment value for each organization based on the information identifying the organization unit name and the identification information of each network asset (step S202). Next, the display unit 113 displays the third-party assessment value for each organization (step S203).

Next, the response acquisition unit 114 acquires a response state to the cyber security risk pointed out for each organization (step S204). Next, the reception unit 115 receives information about the cyber security risk to be displayed (step S205). Next, the display unit 113 displays the response state to the cyber security risk related to the received information of the cyber security risk (step S206). Next, in a case where the cyber security risk is not responded to for a predetermined period or more (S207; YES), the notification unit 116 makes a notification to the person-in-charge terminal of the organization (step S208). On the other hand, in a case where the cyber security risk is responded before the predetermined period has lapsed (S207; NO), the notification unit 116 does not execute S208, and the process ends. The processing according to this flowchart is ended.

In the display device 110 of the present disclosure, the response acquisition unit 114 acquires the response state to the cyber security risk pointed out for each organization, and the display unit 113 displays the response state acquired. As a result, the operator can easily grasp the cyber security risk to be handled.

In the display device 110, in a case where the reception unit 115 receives the information of the cyber security risk to be displayed, the display unit 113 displays the response state to the cyber security risk related to the received information. As a result, since the operator can display only information necessary for the operator, the visibility of the information is improved.

In the display device 110, in a case where the cyber security risk is not responded to for a predetermined period or more, the notification unit 116 makes a notification to the person-in-charge terminal of the organization. As a result, it is possible to urge the person in charge to respond to the cyber security risk.

While the present invention is described with reference to example embodiments thereof, the present invention is not limited to these example embodiments. Various modifications that can be understood by those of ordinary skill in the art can be made to the configuration and details of the present invention within the scope of the present invention.

For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents. Further, it is noted that the inventor's intent is to retain all equivalents of the claimed invention even if the claims are amended during prosecution.

Even in a case where the assessment result of the cyber security risk of the entire organization can be grasped, it may not be possible to identify where in the organization the problem of the cyber security state exists.

An example of an effect of the present disclosure is to provide a display device or the like that can easily grasp a problematic part of a cyber security state in an organization.

Some or all of the above example embodiments may be described as the following Supplementary Notes, but are not limited to the following.

### Supplementary Note 1

A display device including
an identification means for identifying an organization unit name for managing each network asset included in a cyber security risk assessment target and identification information of the each network asset,
an assessment acquisition means for acquiring a third-party assessment value for each organization based on information identifying the organization unit name and the identification information of the each network asset, and
a display means for displaying the third-party assessment value for the each organization.

### Supplementary Note 2

The display device according to Supplementary Note 1, wherein
the assessment acquisition means further acquires a third-party assessment value obtained a predetermined period ago for each organization, and
the display means further displays a difference, in a third-party assessment value, from the predetermined period ago for the each organization.

### Supplementary Note 3

The display device according to Supplementary Note 1, wherein
the assessment acquisition means further acquires a reference value for a third-party assessment for each organization, and
the display means displays a third-party assessment in a different mode according to a difference from the reference value for the each organization.

### Supplementary Note 4

The display device according to Supplementary Note 1, wherein
the assessment acquisition means further acquires a third-party assessment value of an entire organization regarding a cyber security risk, and
the display means displays a third-party assessment value for each organization and the third-party assessment value for the entire organization.

### Supplementary Note 5

The display device according to any one of Supplementary Notes 1 to 4, further including
a response acquisition means for acquires a response state to a cyber security risk pointed out for each organization, wherein
the display means further displays the response state for the each organization.

### Supplementary Note 6

The display device according to Supplementary Note 5, further including
a reception means for receiving information about a cyber security risk to be displayed in the response state, wherein
the display means displays a response state to a cyber security risk related to the information.

### Supplementary Note 7

The display device according to Supplementary Note 5, further including a notification means for making a notification to a person-in-charge terminal of an organization in a case where the cyber security risk is not responded to for a predetermined period or more.

### Supplementary Note 8

The display device according to Supplementary Note 5, wherein the display means displays an updated third-party assessment value for each organization in a case where a change occurs in the response state.

### Supplementary Note 9

A display method executed by a computer, the display method including
identifying an organization unit name for managing each network asset included in a cyber security risk assessment target and identification information of the each network asset,
acquiring a third-party assessment value for each organization based on information identifying the organization unit name and the identification information of the each network asset, and
displaying the third-party assessment value for the each organization.

### Supplementary Note 10

The display method according to Supplementary Note 9, further including
further acquiring a third-party assessment value obtained a predetermined period ago for each organization, and
further displaying a difference in the third-party assessment value from a predetermined period ago for each organization.

### Supplementary Note 11

The display method according to Supplementary Note 9, further including
further acquiring a reference value for third-party assessment for each organization, and
displaying the third-party assessment in a different mode for each organization according to a difference from the reference value.

### Supplementary Note 12

The display method according to Supplementary Note 9, further including
further acquiring a third-party assessment value of the entire organization regarding a cyber security risk, and
displaying the third-party assessment value for each organization and the third-party assessment value of the entire organization.

### Supplementary Note 13

The display method according to any one of Supplementary Note 9 to 12, further including
acquiring a response state to a cyber security risk pointed out for each organization, and
further displaying the response state for each organization.

### Supplementary Note 14

The display method according to Supplementary Note 13, further including
receiving information of a cyber security risk to be displayed in the response state, and
displaying a response state to the cyber security risk related to the information.

### Supplementary Note 15

The display method according to Supplementary Note 13, further including making a notification to a person-in-charge terminal of the organization in a case where the response to the cyber security risk is not responded to for a predetermined period or more.

### Supplementary Note 16

The display method according to Supplementary Note 13, further including displaying the updated third-party assessment value for each organization in a case where a change occurs in the response state.

### Supplementary Note 17

A program causing a computer to execute the steps of
identifying an organization unit name for managing each network asset included in a cyber security risk assessment target and identification information of the each network asset,
acquiring a third-party assessment value for each organization based on information identifying the organization unit name and the identification information of the each network asset, and
displaying the third-party assessment value for the each organization.

### Supplementary Note 18

The program according to Supplementary Note 17 causing a computer to execute the steps of
further acquiring a third-party assessment value obtained a predetermined period ago for each organization, and
further displaying a difference inf a third-party assessment value from a predetermined period ago for each organization.

### Supplementary Note 19

The program according to Supplementary Note 17 causing a computer to execute the steps of
further acquiring a reference value for third-party assessment for each organization, and
displaying the third-party assessment in a different mode for each organization according to a difference from the reference value.

### Supplementary Note 20

The program according to Supplementary Note 17 causing a computer to execute the steps of
further acquiring a third-party assessment value of the entire organization regarding a cyber security risk, and
displaying the third-party assessment value for each organization and the third-party assessment value of the entire organization.

### Supplementary Note 21

The program according to any one of Supplementary Notes 17 to 20 causing a computer to execute the steps of
acquiring a response state to a cyber security risk pointed out for each organization, and
further displaying the response state for each organization.

### Supplementary Note 22

The program according to Supplementary Note 21 causing a computer to execute the steps of
receiving information of a cyber security risk to be displayed in the response state, and
displaying a response state to the cyber security risk related to the information.

### Supplementary Note 23

The program according to Supplementary Note 21 causing a computer to execute the step of making a notification to a person-in-charge terminal of the organization in a case where the cyber security risk is not responded to for a predetermined period or more.

### Supplementary Note 24

The program according to Supplementary Note 21 causing a computer to execute the step of displaying an updated third-party assessment value for each organization in a case where a change occurs in the response state.

### Supplementary Note 25

A display device including
an identification means for identifying identification information of each network asset included in a cyber security risk assessment target and an organization unit name that manages each network device,
an assessment acquisition means for acquiring a third-party assessment value of an entire organization regarding a cyber security risk state, and a third-party assessment value for an organization unit based on the identified identification information and the organization unit name, and
a display means for displaying the third-party assessment value of the entire organization and the third-party assessment value for the each organization units.

### Supplementary Note 26

A display device further including
an assessment acquisition means for acquiring a third-party assessment value regarding a cyber security risk state, and
a display means for displaying a difference in the third-party assessment value from a predetermined period ago for each organization based on the acquired third-party assessment value.

### Supplementary Note 27

A display device further including a display means for generating, for each organization, an image including a third-party assessment value and a difference in the third-party assessment value from a predetermined period ago based on the third-party assessment value regarding a cybersecurity risk state to display the generated image.

### Supplementary Note 28

A display device further including a display means for displaying a third-party assessment value for each organization in a different mode according to a difference from a predetermined reference value based on the third-party assessment value regarding a cyber security risk state.

1. A display device comprising:
a memory storing instructions; and
at least one processor configured to execute the instructions to:
identify an organization unit name for managing each network asset included in a cyber security risk assessment target and identification information of the each network asset;
acquire a third-party assessment value for each organization based on information identifying the organization unit name and the identification information of the each network asset; and
display the third-party assessment value for the each organization.

2. The display device according to claim 1, wherein the at least one processor is further configured to execute the instructions to:
acquire a third-party assessment value obtained a predetermined period ago for each organization, and
display a difference, in a third-party assessment value, from the predetermined period ago for the each organization.

3. The display device according to claim 1, wherein the at least one processor is further configured to execute the instructions to:
acquire a reference value for a third-party assessment for each organization, and
display a third-party assessment in a different mode according to a difference from the reference value for the each organization.

4. The display device according to claim 1, wherein the at least one processor is further configured to execute the instructions to:
acquire a third-party assessment value of an entire organization regarding a cyber security risk, and
display a third-party assessment value for each organization and a third-party assessment value of the entire organization.

5. The display device according to claim 1, wherein the at least one processor is further configured to execute the instructions to:
acquire a response state to a cyber security risk pointed out for each organization, and
display the response state for the each organization.

6. The display device according to claim 5, wherein the at least one processor is further configured to execute the instructions to:
receive information about a cyber security risk to be displayed in the response state, and
display a response state to a cyber security risk related to the information.

7. The display device according to claim 5, wherein the at least one processor is further configured to execute the instructions to:
make a notification to a person-in-charge terminal of an organization in a case where the cyber security risk is not responded to for a predetermined period or more.

8. The display device according to claim 5, wherein the at least one processor is further configured to execute the instructions to:
display an updated third-party assessment value for each organization in a case where a change occurs in the response state.

9. A display method executed by a computer, the display method comprising:
identifying an organization unit name for managing each network asset included in a cyber security risk assessment target and identification information of the each network asset;
acquiring a third-party assessment value for each organization based on information identifying the organization unit name and the identification information of the each network asset; and
displaying the third-party assessment value for the each organization.

10. A non-transitory recording medium storing a program for causing a computer to execute the steps of:
identifying an organization unit name for managing each network asset included in a cyber security risk assessment target and identification information of the each network asset;
acquiring a third-party assessment value for each organization based on information identifying the organization unit name and the identification information of the each network asset; and
displaying the third-party assessment value for the each organization.
